(19) United States
(12) Patent Application Publication
(10) Pub. No.: US 2007/0221016 A1
(43) Pub. Date: Sep. 27, 2007

(54) Buoyant metal composite pliers

(75) Inventors: Richard Herbst, Sarasota, FL (US); Dale Thomas Walker, Palm Harbor, FL (US); Robert Brady, Sarasota, FL (US); Erik Holmen, Sarasota, FL (US)

Correspondence Address: NELSON MULLINS RILEY & SCARBOROUGH, LLP, 1320 MAIN STREET, 17TH FLOOR, COLUMBIA, SC, 29201, US

(73) Assignee: XTools, LLC, Bradenton, FL (US)

(21) Appl. No.: 11/385,943

(22) Filed: Mar. 21, 2006

(51) Int. Cl. B25B 7/02; B25B 7/00

(52) U.S. Cl. 81/415; 81/427.5; 81/900

(57) ABSTRACT

A pair of composite material substantially buoyant-in-water hand pliers including a pair of elongated metallic lever members each having a handle portion and a jaw portion and formed of higher rigidity metallic material having a density greater than water. The lever members are pivotally connected together at common central portions between the jaw and handle portions. Each handle portion is substantially encapsulated by an elongated molded-in-place contoured grip formed of material buoyant in water wherein the effective density of the pliers is in very close proximity to that of water. Uniquely configured jaw inserts are also provided.

### CROSS-REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to hand tool construction, and more particularly to a lightweight metal composite pair of pliers having water buoyant characteristics for use by fishermen and boaters and others using such tools in the vicinity of water and/or electricity.

2. Description of Related Art

Boaters and fishermen and others who use hand tools in the vicinity of water are notorious for dropping hand tools irretrievably into the water. If the tool happens to be fabricated of metallic material, magnets may be used at the end of a long flexible line to afford some chance of retrieval. Additionally, use of metallic hand tools around salt water will quickly cause substantial, detrimental corrosion in the form of surface rust on such hand tools. Moreover, those conventional pliers which include a wire cutter do not work well at cutting high-tensile strength steel or stainless steel solid or braided leader wire. Another concern for users of such hand tools is with respect to the presence of water on the ground or floor surface or carelessness while using a conductive hand tool around sources of electric power and energized wiring and connectors therefor.

To address the issue of buoyancy in water, Kreitz teaches a set of floating pliers in U.S. Pat. No. 4,185,523 wherein a block of closed cell polymeric foam is inserted between the handle portions of the lever members to provide sufficient flotation to render the pliers buoyant and also to provide a resilient automatic jaw opening mechanism during use.

In U.S. Pat. No. 5,865,077, Moffitt discloses floating, non-conductive hand tools in the form of pliers or channel locks which utilize non-conductive lever members pivotally connected together. Water buoyancy is achieved either by entrapping gas or air within a sealed airtight hollow cavity formed within the handle portion of each lever member by special manufacturing methods and apparatus and/or by providing a closed-bottomed sheathing material having a low density substantially below that of water fitted over the end of the handle portion of each lever member. A further enhancement of that disclosure by Moffitt is shown in U.S. Pat. No. 6,202,518 which additionally teaches wear resistant removable jaw members and a line cutter for nylon and fabric line only and being interconnected to one of the handle portions of one lever member thereof.

Pliers made from a plastic material are disclosed in U.S. Pat. No. 4,023,450 invented by Ygfors whose basic object is to produce pliers suitable for picking up small objects.

U.S. Pat. No. 6,776,073 discloses a light weight non-conductive, substantially non-corrosive water buoyant pair of pliers which achieves water buoyancy through the cooperative effects of an elongated low density sleeve open at each end thereof and fitted over the handle portions of each lever member to sealingly enclose one or more open air cavities formed in outwardly opening fashion into each handle portion. Additionally, an advisory detent and physical restraint to excessive jaw portion opening, which, if opened there beyond to receive an object which is held between the jaws by the manual squeezing together of the handle portions could lead to pliers damage, is also provided.

### BRIEF SUMMARY OF THE INVENTION

This invention is directed to a pair of composite material substantially buoyant-in-water hand pliers including a pair of metallic lever members each having a handle portion and a jaw portion and formed of higher rigidity material having a density greater than water. The lever members are pivotally connected together at common central portions between the jaw and handle portions. Each handle portion is substantially encapsulated by an elongated molded-in-place contoured sheath formed of material buoyant in water grips wherein the effective density of the pliers is in very close proximity to that of water. Uniquely configured jaw inserts are also provided.

It is therefore an object of this invention to provide a lightweight pair of metal composite pliers.

It is another object of this invention to provide a substantially non-corrosive pair of pliers which are substantially water buoyant, particularly in salt water.

In accordance with these and other objects which will become apparent hereinafter, the instant invention will now be described with reference to the accompanying drawings.

### BRIEF DESCRIPTION OF THE SEVERAL VIEWS OF THE DRAWING(S)

FIG. 1 is a perspective view of the invention with the jaws in the open position.

FIG. 2 is an exploded perspective view of the invention.

FIG. 3 is a side elevation view of the invention with the jaws in the closed orientation.

FIG. 4 is a top plan view of FIG. 3.

FIG. 5 is an enlargement of area 5 in FIG. 3.

FIG. 6 is an enlargement of area 6 in FIG. 4.

FIG. 7 is a side elevation view of FIG. 1.

FIG. 8 is a left end elevation view of FIG. 7.

FIG. 9 is a right end elevation view of FIG. 7.

FIG. 10 is an outside elevation view of the lower jaw/upper handle.

FIG. 11 is an inside elevation view of FIG. 10.

FIG. 12 is a left end elevation view of FIG. 10.

FIG. 13 is a bottom plan view of FIG. 10.

FIG. 14 is an outside elevation view of the upper jaw/lower handle.

FIG. 15 is an inside elevation view of FIG. 14.

FIG. 16 is a top plan view of FIG. 14.

FIG. 17 is a left end elevation view of FIG. 15.

FIG. 18 is a side elevation view of the molded-in-place upper grip.

FIG. 19 is a top plan view of FIG. 18.

FIG. 20 is a left end elevation view of FIG. 18.

FIG. 21 is a right end elevation view of FIG. 18.

FIG. 22 is a perspective view of the lower molded-in-place grip.

FIG. 23 is a top plan view of FIG. 23.

FIG. 24 is a side elevation view of FIG. 22.

FIG. 25 is a bottom plan view of FIG. 24.

FIG. 26 is a top plan view of FIG. 24.

FIGS. 27 and 28 are perspective views of the upper jaw insert.

FIGS. 29 and 30 are perspective views of the lower jaw insert.

FIGS. 31 and 32 are perspective views of the female pivot ring.

FIGS. 33 and 34 are perspective views of the male pivot ring.

FIGS. 35 and 36 are perspective views of the removable blade.

FIGS. 37 and 38 are perspective views of the removable anvil.

FIG. 39 is a perspective view of the pivot bearing.

FIG. 40 is a plan view of the working surface of the upper jaw insert.

FIG. 41 is a section in the direction of arrows 41-41 in FIG. 40.

FIG. 42 is a section view in the direction of arrows 42-42 in FIG. 40.

FIG. 43 is a plan view of the working surface of the lower jaw insert.

FIG. 44 is a section view in the direction of arrows 44-44 in FIG. 43.

FIG. 45 is a section view in the direction of arrows 45-45 in FIG. 43.

### DETAILED DESCRIPTION OF THE INVENTION

### LIST OF COMPONENTS

10 Pliers
12 Upper Handle Assembly
14 Lower Handle Assembly
16 pivot assembly
18 upper jaw/lower handle lever member
20 lower jaw/upper handle lever member
22 upper jaw
24 lower jaw
26 lower handle
28 upper handle
30 pivot bore
32 mold cavity
34 blade support
36 blade
38 lower jaw face
40 lower jaw end
42 pin
44 anvil support
46 anvil
48 anvil mounting hole
50 pivot bore
52 blade mounting hole
54 mold cavity
56 upper jaw face
58 upper jaw end
60 upper grip
62 palm recess
64 lower grip
66 finger recess
68 lower jaw bearing face
70 upper jaw insert
72 upper jaw tooth
73 lower jaw tooth
74 upper jaw tooth cavity
75 lower jaw tooth cavity
76 mounting tab
78 upper jaw bearing face
80 mounting hole
82 tip of jaw insert
84 jaw insert interface
86 jaw cavity
88 flange
90 lower jaw insert
92 gripping grooves
94 female pivot ring
96 flange
98 main body
100 female thread
102 tightening holes
104 male pivot ring
106 flange
108 main body
110 male threads
112 tightening holes
114 cutting edge
116 blade mounting hole
118 anvil surface
120 anvil mounting hole
122 pivot bearing
124 flange
126 main body
128 pivot ring bearing surface
130 bearing face
132 pivot spacer
134 pivot limiter slot
136 pivot pin
138 pivot pin
140 pivot pin receiving hole

This invention relates generally to hand tool construction, and more particularly to a lightweight metal composite pair of pliers having water buoyant characteristics for use by fishermen and boaters and others using such tools in the vicinity of water and/or electricity. Since the pliers are intended to be used outdoors and around water, all materials are either non-corrosive or have been protected from corrosion with various protective treatments and finishes.

The two halves or lever members of the pliers are constructed of a lightweight metal, either aluminum or magnesium, with thin walls for weight reduction and ribbing for strength. The exposed surfaces are protected from corrosion and other damage with a combination of chromate treatment, anodic treatment and powder coating. Each handle of each lever member has an exposed loop on the end to provide for the attachment of a lanyard.

The jaws are further enhanced with the addition of separate replaceable jaw inserts having toothed faces made of a harder material such as stainless steel or tungsten carbide. The teeth interlock when the pliers are squeezed shut to provide a superior gripping ability not possible with simple flat or ribbed jaw faces alone. The harder material will also extend the useful life of the jaw inserts. It will be possible to replace the jaw inserts using simple household tools, if necessary, or if jaws with a different gripping pattern are made available as an option. The jaws may face directly forward for a symmetrical look, or be tilted downward or offset for ease of use in such application as fish hook removal.

The pliers have a cutting feature, separate from the jaws including a blade and anvil. Both blade and anvil are made of tungsten carbide. The blade and anvil are mounted in such a way that the user can replace them with the use of simple household tools, if required. The cutting edge of the blade has a sharp v-shape, and the anvil is flat and mounted normal to the blade. The pliers will thus cut monofilament, braided fishing line or steel leader material.

The pivot feature for the two lever members of the pliers provides for a limited rotation, not to exceed a jaw opening of about 0.8 inches. There is an internal spring feature that keeps the unloaded pliers in the open position, but offers only slight resistance when squeezing the pliers closed. The pivot feature has an outer visible ring on each side of the pliers, joined through the halves of the pliers, and forming an open hole through the axis of rotation. There is an internal plastic bearing that keeps the rotation of the pliers smooth.

Each of the pliers handles are covered with a low-density closed cell molded foam grip. These grips will provide sufficient material so as to bring the average specific gravity of the pliers to less than or in very close proximity to 0.0336 lbs/in³ (1 gm/cc), thus achieving buoyancy in both fresh water and seawater. The foam grips will have textured, contoured surfaces that allow a person with average sized hands to comfortably operate the pliers.

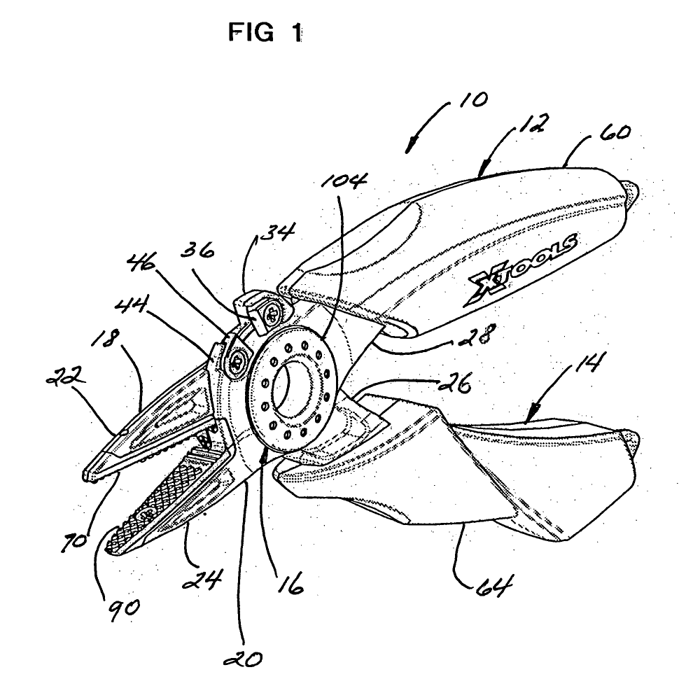

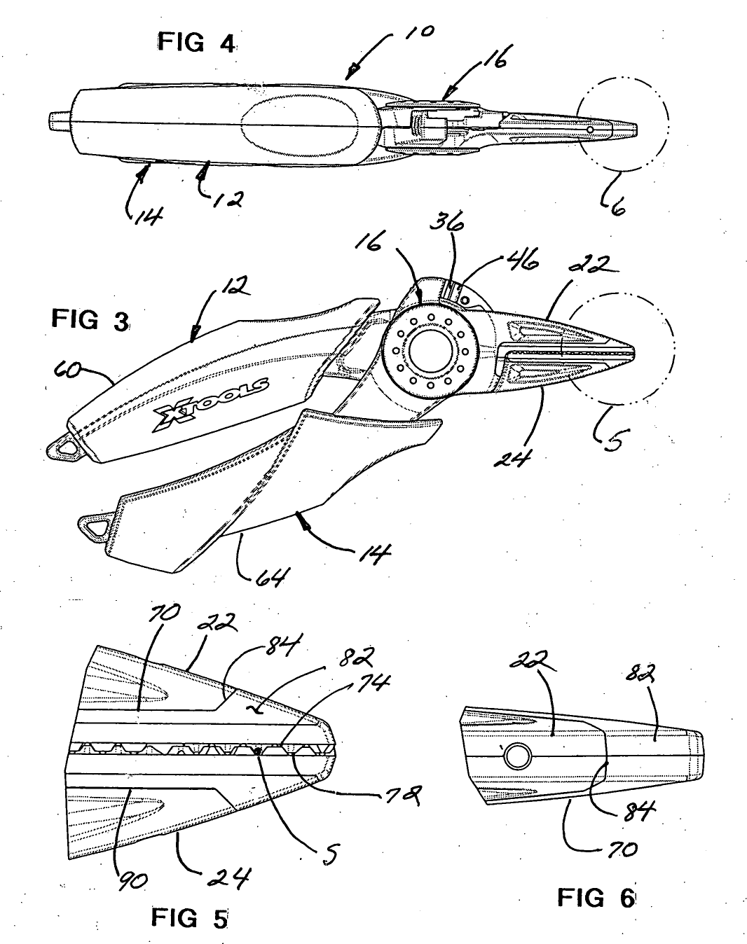

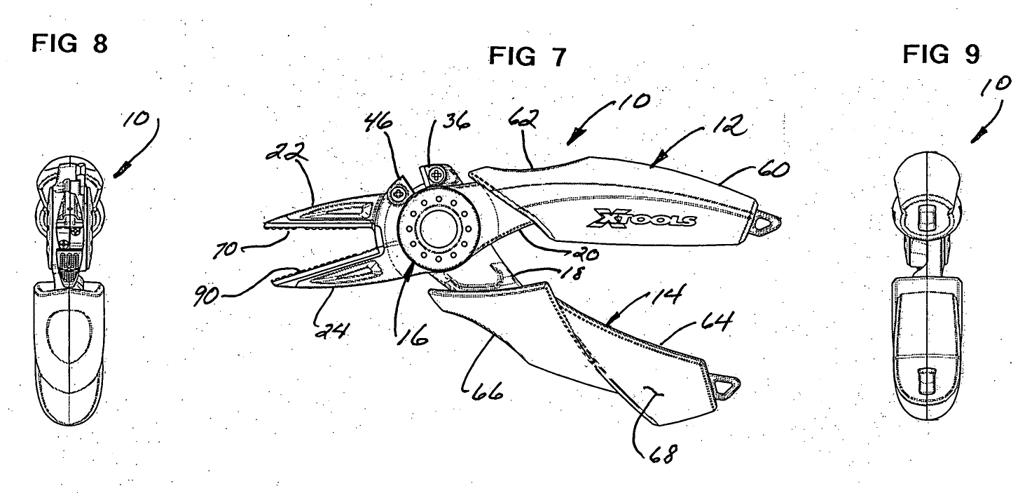

Referring more specifically to the drawings, and firstly to FIGS. 1 to 9, the invention is there shown generally at numeral 10 and includes a first handle assembly 12 and a second handle assembly 14 which are pivotally connected together by a pivot assembly 16 having a pivot axis A which is positioned in the central portion of each of the handle assemblies 12 and 14. Each of the handle assemblies 12 and 14 include lever members 18 and 20, respectively. Each of these lever members 18 and 20 include an upper jaw 22 and a lower jaw 24 and a lower handle 26 and an upper handle 28, respectively.

The pliers 10 further include metallic jaw inserts 70 and 90 which preferably matably engage together as will be described in more detail herebelow, along with a line and wire cutter mechanism formed of a carbide blade 36 and a carbide anvil 46, again described in more detail herebelow. Each of the handle assemblies 12 and 14 further include molded-in-place closed cell foam grips 60 and 64, respectively, which are molded in place over the handles 28 and 26, respectively.

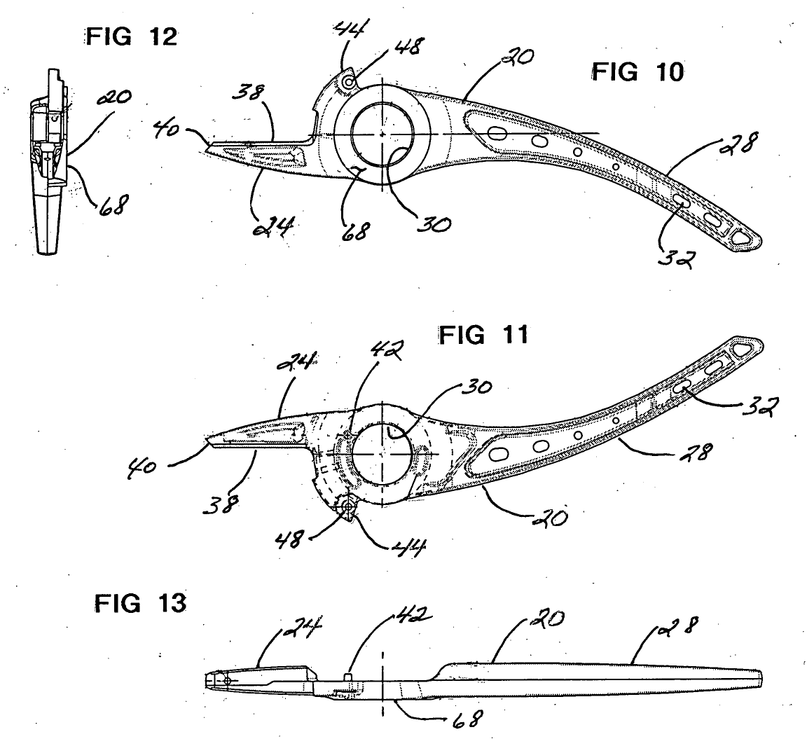

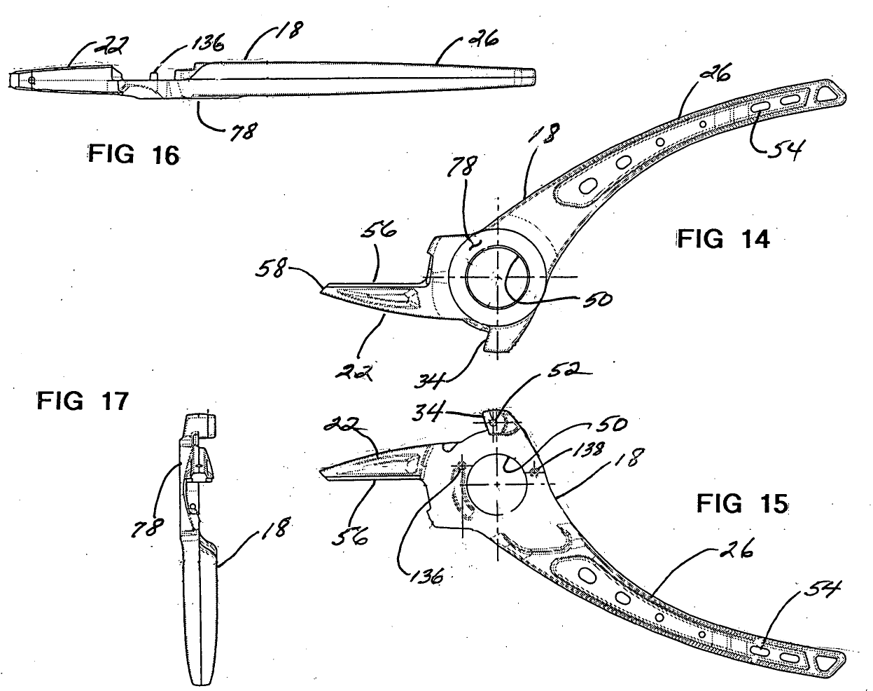

Referring now to FIGS. 10 to 17, the lever members 18 and 20 are there shown in detail. Each of these lever members 18 and 20 are mold formed as a unit of base material commercially known as ADC-12, a lightweight metallic aluminum or magnesium material having thin walls for weight reduction and ribbing for strength. The exposed surfaces are protected from corrosion and other damage with a combination of chromate and anodic treatment, followed by powder coating, the preferred powder coat being supplied by DuPont under the trademark designation, SALVADILLO PFA-500-M9.

Each handle 26 and 28 includes a lightened cross section having through apertures 32 which both reduce weight at the least critical structural point along the neutral axis of each handle 26 and 28 and provide for more thorough retention and interlocking engagement of the corresponding grip 60 and 66 when they are molded in place over the corresponding handle 26 and 28.

Each of the lever members 18 and 20 also include cylindrical pivot assembly support surface 30 and 50, respectively, and outer bearing flange mating surfaces 68 and 78. The lower and upper jaws 24 and 22 include facing surfaces 38 and 56, respectively along with an anvil support surface 44 and a blade support surface 34 and fastener receiving apertures 48 and 52, respectively.

Displacement limiting pins 42, 136 and 138 are also provided on the corresponding inwardly facing surfaces of the lever members 20 and 18, respectively, the function of which will be described in more detail herebelow.

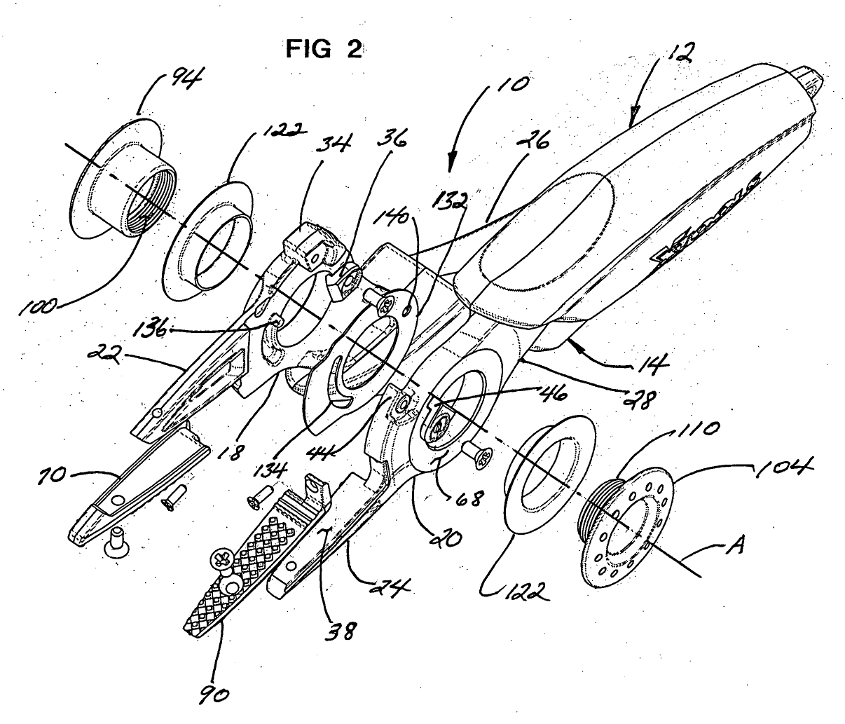

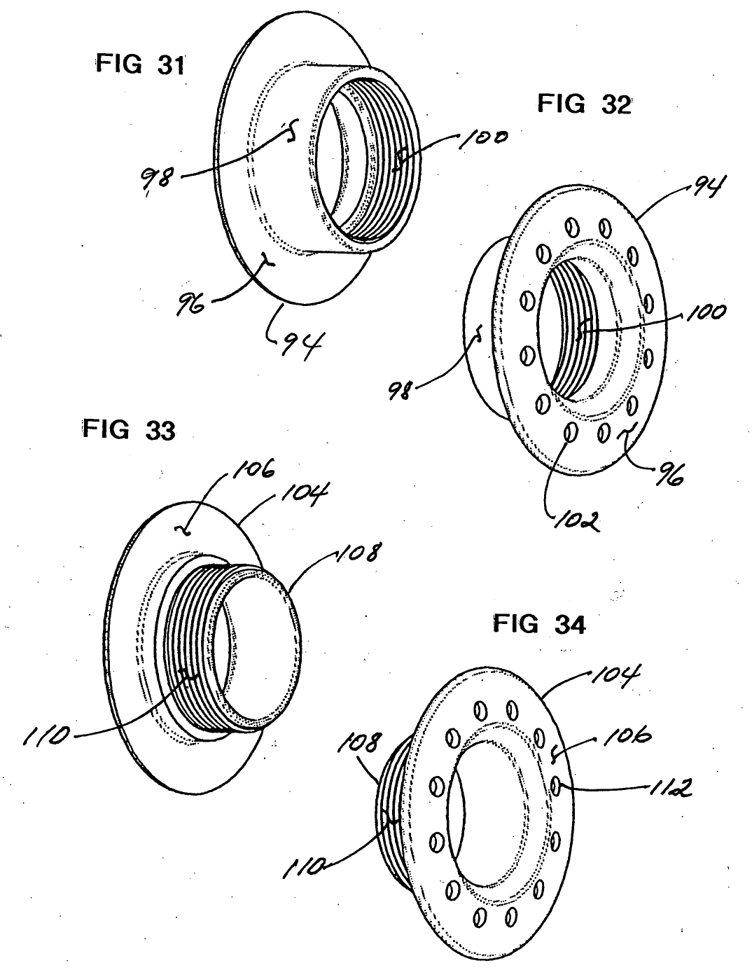

Turning particularly to FIGS. 2, 11-17 and 31-34, the pivot assembly 16 and the components thereof are there shown. The pivot assembly 16, which pivotally connects the handle assemblies 12 and 14 and the corresponding molded lever members 18 and 20, respectively, together bears upon the pivot bores 30 and 50 and the thrust or flange engaging surfaces 68 and 78, respectively. Positioned between the inner surfaces of the lever members 18 and 20 is a flat pivot spacer 132 having pin-receiving aperture 140 and opposing pin slot 134. The interaction between the previously described limiting pins 42, 136 and 138 control the maximum opening pivotal movement of the lever members 18 and 20 so as to avoid damage thereto. Two pivot bearings 122 formed of machine Delrin plastic material bear against the bearing faces 68 and 78 and have longitudinally extending cylindrical flanges which receive the cylindrical portions of the female pivot ring 94 and the male pivot ring 104. The male and female pivot rings 104 and 94 threadably engage together on male threads 110 and female threads 100, respectively, to hold the entire pivot assembly 16 together and provide adjustment for pivotal tightness which is adjusted through the use of tool-engaging apertures 102 in flange 96 and 112 formed into flange 106 in FIGS. 32 and 34.

The pivot bearing 122 as best seen in FIG. 39, includes outwardly opposing flat annular bearing surfaces 124 and 130 of flange 123, as well as outer cylindrical bearing surface 126 and 128.

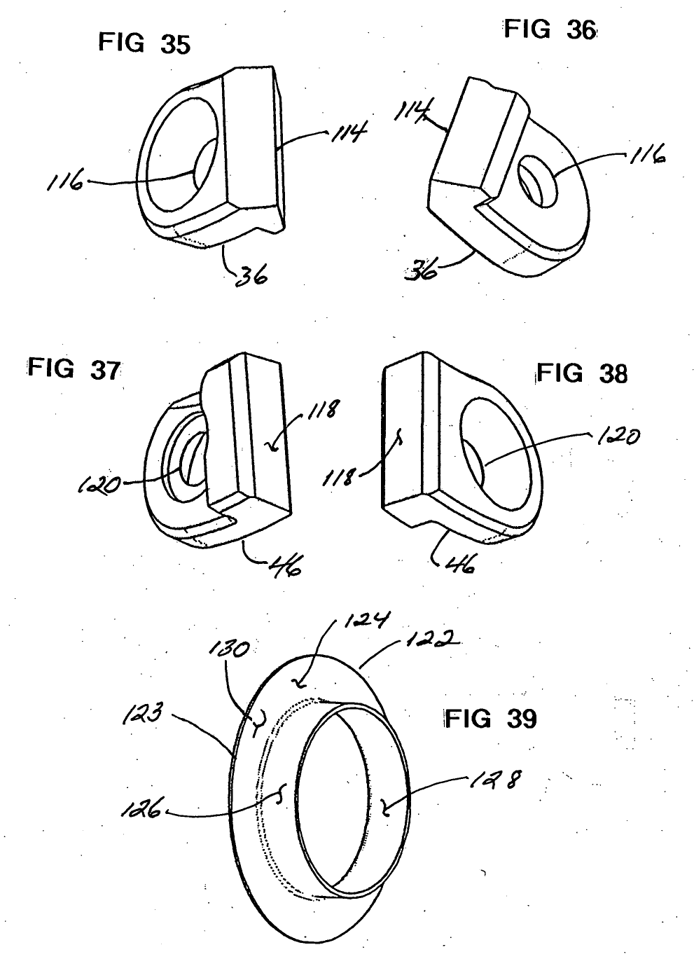

In FIGS. 35 to 38, the blade 36, which is replaceably attachable through mounting apertures 116, is formed of tungsten carbide material having a cutting edge 114, while the anvil 46, also formed of tungsten carbide material, and having its own mounting aperture 120, includes a flat anvil surface 118 which, when mounted to surface 44, and blade 36 is mounted to surface 34, are arranged to come together in normal or full cutting edge contact against the anvil surface 118 when the jaws 22 and 24 and jaw inserts 70 and 90 forcefully come together.

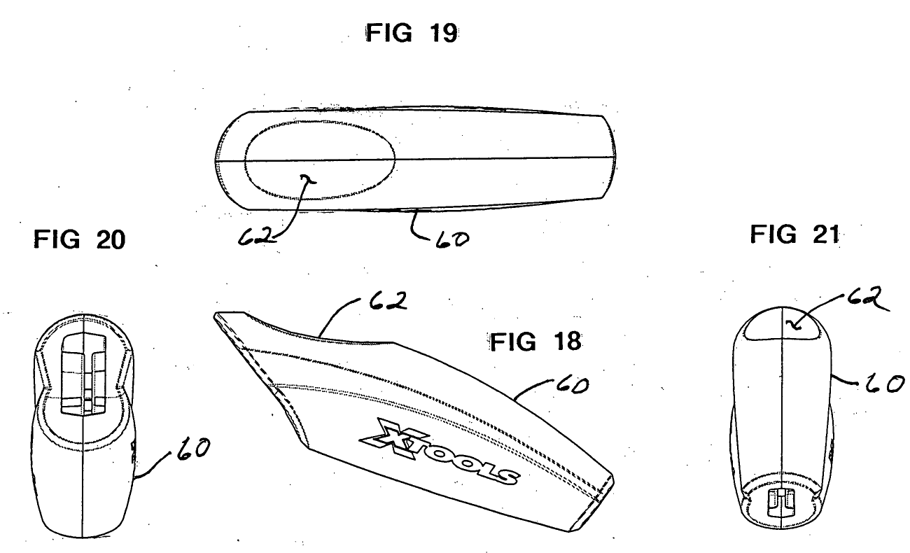

Referring now to FIGS. 18 to 21, the upper grip 60 is formed of molded-in-place or “molded over” EVA closed cell foam material having a density described herebelow which is substantially lower than that of water. The web of the hand fits snugly against concave surface 62 when applying squeezing force to close the jaws of the pliers 10.

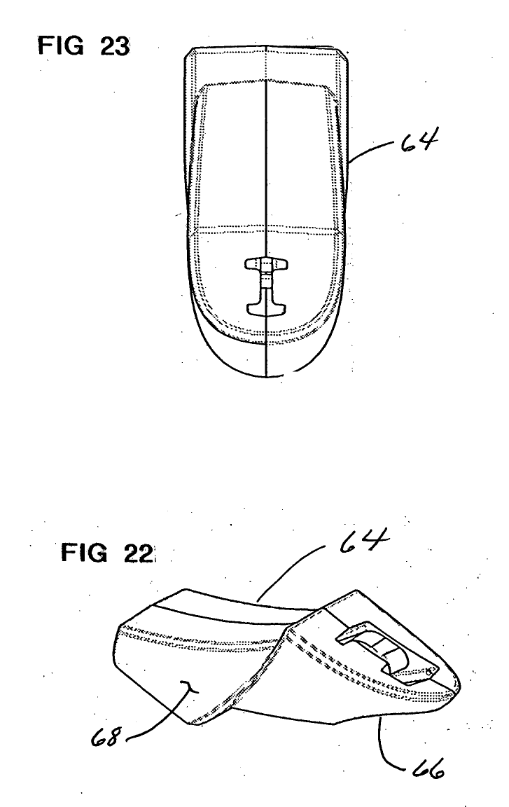

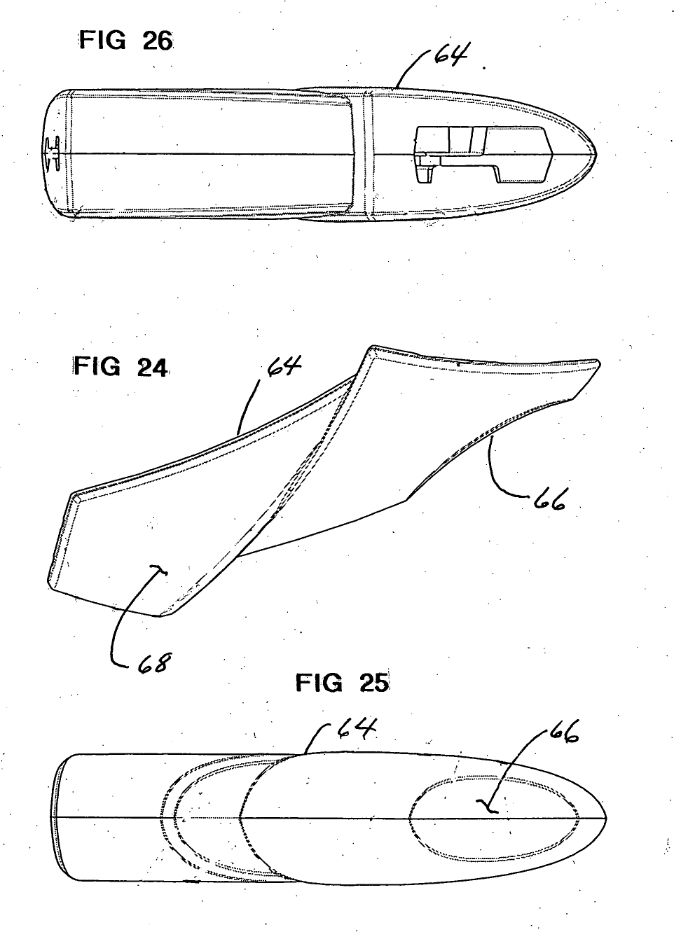

In FIGS. 22 to 26, the molded-in-place lower grip 64, also formed of EVA closed-cell foam material and “molded over” the handle 26, is sculptured and contoured so as to provide a high degree of finger-squeezing comfort at area 68 and an index finger relief contour at 66. By enhancing and increasing the surface area and compliance to the natural shape of the user's hand, increased squeezing and gripping capabilities are thus provided.

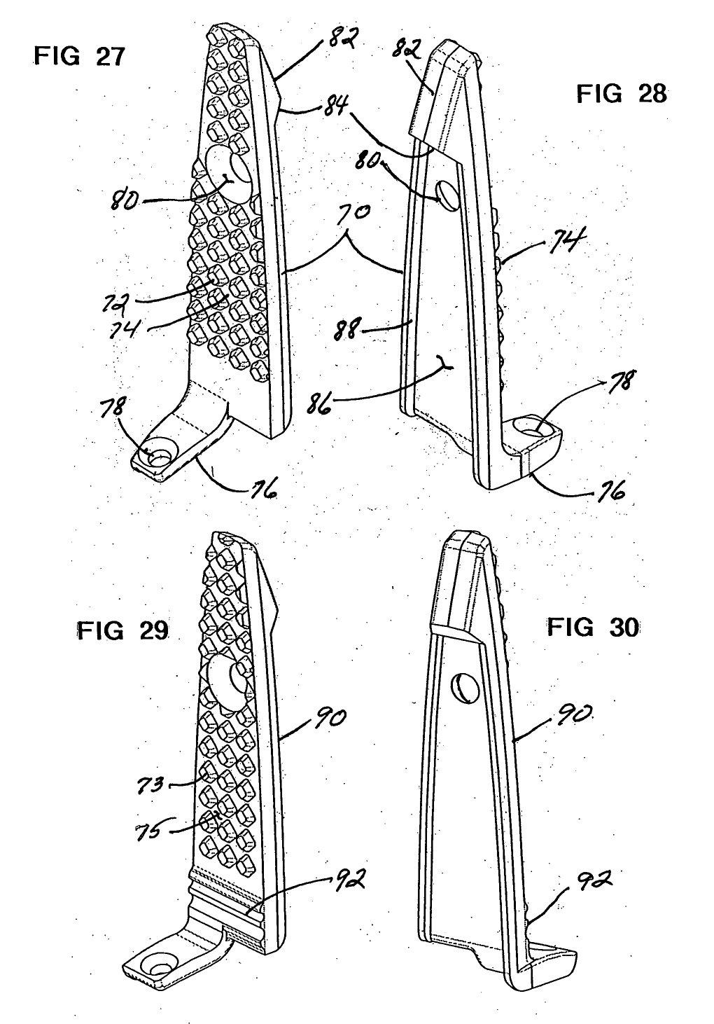

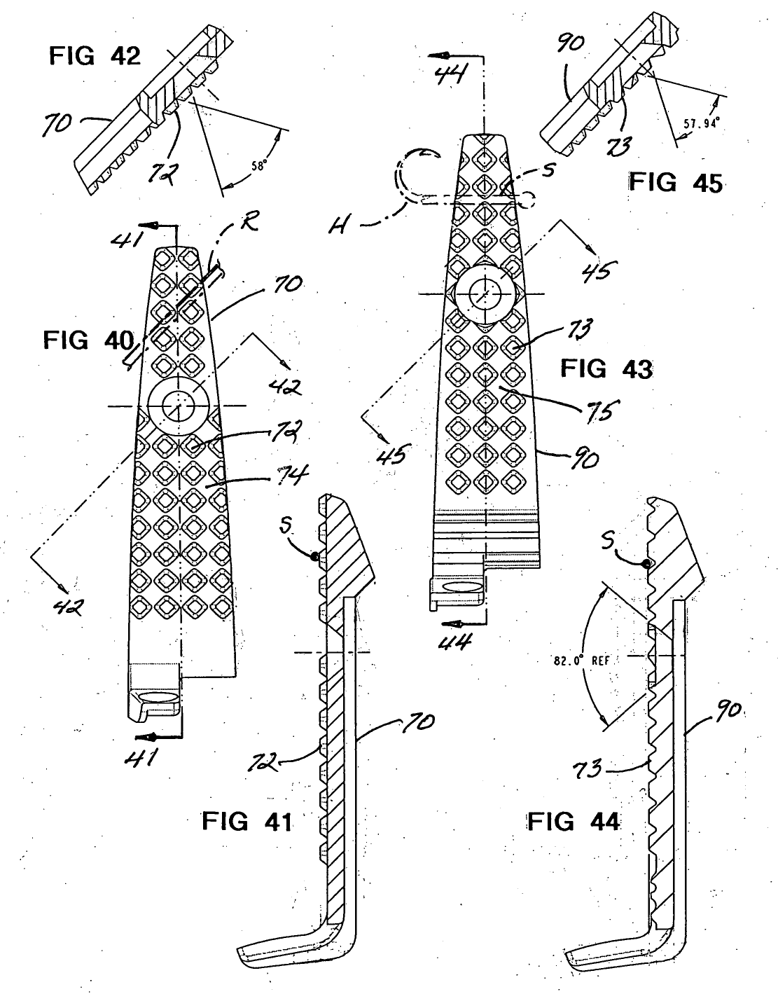

Turning now to FIGS. 27 to 30, the upper and lower jaw inserts 70 and 90 are there shown. These jaw inserts 70 and 90 are formed of machined or cast BASF Catamold M2, heat treated to a hardness of at least 62 HRC. This material has a density of about 0.293 lbs/in³ and provides an extremely durable and highly impact and scratch resistant mating surfaces. Each of the jaw inserts 70 and 90 also include a series or array of evenly spaced jaw teeth at 72 and 73 which define pockets at 74 and 75, respectively, therebetween. By offsetting the array of teeth 72 and corresponding pockets 74 of the upper jaw insert 70 from the teeth 73 and pockets 75 of the lower jaw insert 90, the teeth 72 and 73 will come together and overlap and interengage or interlock as best seen in FIG. 5. By this arrangement, small diameter shafts such as the shank S of a fishing hook H as seen in FIGS. 45, 41, 43 and 44, may be more securely held for removal from a fish or for sharpening. Moreover, because of the diamond-shaped array as best seen in FIGS. 40 and 43, an elongated slender rod R may be held between the spaced offset teeth 72 and 73, respectively at the diagonal angle of preferably 450 as shown.

Physical Property

Table I herebelow discloses the details of the physical system in terms of its total and component volume, the densities, mass of each, and the percentage of each to the respective totals. The grips have been singled out as being the sole source of buoyancy, the remaining components having a substantially higher density than that of water which for reference is indicated above to be 0.036 lbs/in³.

TABLE I
System Physical Values

| | Volume | Density | Mass | % Total | % Total |
|---|---|---|---|---|---|
| Component | (in³) | (lbs/in³) | (oz.) | Vol. | Mass |
| (2) Grips | 6.35 | .0074 | .75 | 74.6 | 16.3 |
| All Other | 2.16 | .1111 | 3.84 | 25.4 | 83.7 |
| Total | 8.51 | .0337 | 4.59 | 100.0 | 100.0 |

The individual component values are shown in Table II herebelow. Each of the individual components are described with respect to their volume, density, mass, percentage of volume and percentage of total mass of the entire pliers assembly.

TABLE II
Component Physical Values

| | Volume | Density | Mass | % Total | % Total |
|---|---|---|---|---|---|
| Component | (in³) | (lbs/in³) | (oz.) | Vol. | Mass |
| Upper Handle/Jaw | .90 | .098 | 1.41 | 10.6 | 30.7 |
| Lower Handle/Jaw | .87 | .098 | 1.36 | 10.2 | 29.6 |
| Upper Grip | 3.15 | .0074 | .37 | 37.0 | 8.1 |
| Lower Grip | 3.20 | .0074 | .38 | 37.6 | 8.3 |
| Lower Jaw Insert | .05 | .2923 | .24 | 0.6 | 5.2 |
| Upper Jaw Insert | .05 | .2923 | .23 | 0.6 | 5.0 |
| Cutter Blade & Anvil | .02 | .538 | .17 | 0.2 | 3.7 |
| Pivot Assembly | .19 | .125 | .38 | 2.2 | 8.3 |
| Fasteners | .08 | .040 | .05 | .9 | 1.1 |
| Total | 8.51 | .0337 | 4.59 | 100.0 | 100.0 |

In comparing these values, it should be readily discernable that the ratio of densities between the grips 60 and 64 to the lever members 18 and 20 and the pivot assembly 16 is in the range of about 1 to 15. The ratio of masses between the lever members 18 and 20 and the pivot assembly 16 to the grips 60 and 64 is in the range of 5 to 1. The lever members 18 and 20, along with the pivot assembly 16 provide about a quarter (25%) of the total volume of the pliers 10, while the grips 60 and 64 provide about three-quarters (75%) of the total volume of the pliers 10 to achieve the desired buoyancy of approximately that of water.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. A pair of composite material substantially buoyant-in-water hand pliers comprising:
a pair of elongated substantially lever members each having a handle and a jaw and a pivot assembly pivotally connecting said lever members together at a central portion between said jaw and handle of each said lever members;
each said handle having recessed cavities formed into opposing side surfaces thereof;
a handle grip mold-formed in place over each of said handles and being formed of low density closed-cell foam material buoyant in water and extending over and enclosing said cavities of each of said handles, said grips cooperating to render said pliers substantially buoyant in water.

2. A pair of hand pliers as set forth in claim 1, wherein:
the ratio of densities of said grips to each said lever member and said pivot assembly is in the range of 1:15.

3. A pair of hand pliers as set forth in claim 1, wherein:
the ratio of masses of said lever members and said pivot assembly to said grips is in the range of 5:1.

4. A pair of hand pliers as set forth in claim 1, wherein:
said lever members and said pivot assembly provide about ¼ of total volume of said pliers while said grips provide about ¾ of the total volume of said pliers to achieve a neutral buoyancy of said pliers in water.

5. A pair of composite material substantially buoyant-in-water hand pliers comprising:
a pair of elongated substantially lever members each having a handle and a jaw and a pivot assembly pivotally connecting said lever members together at a central portion between said jaw and handle of each said lever members;
each said handle portion having recessed cavities formed into opposing side surfaces thereof;
a handle grip mold-formed in place over each said handle and being formed of low density closed-cell foam material buoyant in water and extending over and enclosing said cavities and said handles;
a jaw insert connected to a facing surface of each of said jaws, said jaw inserts formed of metallic material having a density greater than that of water and having spaced offset interengaging teeth for increased gripability of objects;
said grips having a volume sufficient to render said pliers substantially buoyant in water.

6. A pair of hand pliers as set forth in claim 5, wherein:
each said grip has a density of about 0.07 lbs/in³, the density of said lever members is about 0.1 lbs/in³, and the net density of said pliers is about that of water.

7. A pair of hand pliers as set forth in claim 5, wherein:
the ratio of densities of said grips to each said lever member and said pivot assembly is in the range of 1:15.

8. A pair of hand pliers as set forth in claim 5, wherein:
the ratio of masses of said lever members and said pivot assembly to said grips is in the range of 5:1.

9. A pair of hand pliers as set forth in claim 5, wherein:
said jaw inserts include offset mating heel tabs which protect said central portions and said pivot assembly when an object is forced between said jaw inserts against said heel tabs.
